(19) United States
(12) Patent Application Publication
(10) Pub. No.: US 2025/0048298 A1
(43) Pub. Date: Feb. 6, 2025

(54) SYNCHRONIZATION OF DATA BY A USER EQUIPMENT IN CONNECTION WITH CONNECTED DEVICES

(71) Applicant: Nokia Technologies Oy, Espoo (FI)

(72) Inventors: Daniel Philip VENMANI, Massy (FR); Xuan HE, Massy (FR); Abdelaali CHAOUB, Massy (FR)

(21) Appl. No.: 18/773,759

(22) Filed: Jul. 16, 2024

(30) Foreign Application Priority Data
Jul. 31, 2023 (GB) 2311716.1

(51) Int. Cl. H04W 56/00

(52) U.S. Cl. CPC H04W 56/0045; H04W 56/0005; H04W 56/0055

(57) ABSTRACT

A method includes receiving, by a user equipment (UE), a first signal from a first apparatus, the first signal comprising a first data for presentation by a second apparatus and a second data for presentation by a third apparatus, the first data and the second data being synchronized with each other in time. The UE extracts the first and second data from the first signal, and determines a timing for transmitting a second signal that comprises the first data to the second apparatus and for transmitting a third signal that comprises the second data to the third apparatus, the timing configured to approximately synchronize in time presentation of the first data and second data by the respective second and third apparatuses. The UE transmits the second signal to the second apparatus based on the timing, and transmits the third signal to the third apparatus based on the timing.

### FIELD

Various example embodiments relate generally to wireless networks and, more particularly, to synchronizing data by a user equipment (UE) in connection with devices connected to the UE.

### BACKGROUND

Current technologies allow connection of a user equipment (UE) to multiple peripheral devices. These devices may be paired, or tethered, to the UE by a wireless connection, such as an Institute of Electrical and Electronics Engineers (IEEE) 802.15 wireless standard connection. Since the processing (e.g., queuing, buffering, etc.) delays and transmission delays in the multiple peripheral devices may not be identical, data (e.g., media data, videostream data and/or audiostream data) transmitted to one peripheral device connected to the UE may not be presented by that device synchronously with data that is transmitted to another peripheral device connected to the UE. Further, data that is received from individual device towards the UE may also be unsynchronized.

### SUMMARY

In an aspect of the present disclosure, a method includes receiving, by a user equipment (UE), a first signal from a first apparatus, where the first signal includes a first data for presentation by a second apparatus in communication with the UE and a second data for presentation by a third apparatus in communication with the UE, where the first data and the second data are synchronized with each other in time; extracting, by the UE, the first data from the first signal; extracting, by the UE, the second data from the first signal; determining a timing for transmitting a second signal that includes the first data to the second apparatus and for transmitting a third signal that includes the second data to the third apparatus, where the timing is configured to approximately synchronize in time presentation of the first data by the second apparatus and presentation of the second data by the third apparatus; transmitting the second signal to the second apparatus based on the timing; and transmitting the third signal to the third apparatus based on the timing.

In an aspect of the method, the method may further include determining at least a processing and transmission delay of the second apparatus, where determining the timing may include determining the timing based at least on the processing and transmission delay of the second apparatus.

In an aspect of the method, the method may further include determining a processing and transmission delay of the third apparatus, where the determining the timing may include determining the timing based at least on the processing and transmission delay of the third apparatus.

In an aspect of the method, the transmitting the second signal to the second apparatus based on the timing may include transmitting the second signal to the second apparatus at a first time, and the transmitting the third signal to the third apparatus based on the timing may include transmitting the third signal to the third apparatus at a second time different from the first time.

In an aspect of the method, the first time may precede the second time.

In an aspect of the method, the method may further comprise encoding, based on the timing, a first presentation time offset in the second signal.

In an aspect of the method, the first data may include a first datastream and the second data may include a second datastream.

In an aspect of the method, the first datastream may be one of an audio datastream or a video datastream and the second data may be the other of the audio datastream and the video datastream.

In an aspect of the method, the method may further include decoding and processing the first data.

In an aspect of the method, the method may further include decoding and processing the second data.

In an aspect of the present disclosure, a method includes receiving, by a user equipment (UE), a first signal including first data from a first apparatus in communication with the UE; receiving, by the UE, a second signal including second data from a second apparatus in communication with the UE; determining, by the UE, a timing which synchronizes the first data and the second data in time; generating, by the UE and based on the timing, a third signal including the first data and the second data, where the first data and the second data are synchronized in time in the third signal; and transmitting the third signal to a third apparatus.

In an aspect of the method, the determining the timing may include determining a processing and transmission delay of the first apparatus.

In an aspect of the method, the determining the timing may include determining a processing and transmission delay of the second apparatus.

In an aspect of the method, the generating the third signal may include mixing the first data of the first signal with the second data of the second signal into the third signal.

In an aspect of the method, the generating the third signal may include synchronizing a presentation time of the first data with a presentation time of the second data in the third signal.

In an aspect of the method, the synchronizing the presentation time of the first data with the presentation time of the second data in the third signal may include synchronizing data packets of the first data with data packets of the second data in time.

In an aspect of the method, the first data may include a first datastream and the second data may include a second datastream.

In an aspect of the method, the first datastream may be an audio datastream and the second data may be a video datastream.

In an aspect of the method, the method may further comprise encoding and processing the first data.

In an aspect of the method, the method may further comprise encoding and processing the second data.

In an aspect of the present disclosure, a user equipment (UE) includes at least one processor and at least one memory storing instructions which, when executed by the at least one processor, cause the user equipment at least to perform any of the foregoing methods.

In an aspect of the present disclosure, a processor-readable medium stores instructions which, when executed by at least one processor of an apparatus, causes the apparatus at least to perform any of the foregoing methods.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment (UE) that includes multiple devices connected to the UE, according to one illustrated aspect of the disclosure;

FIG. 2 is a diagram of example components of a network system, according to one illustrated aspect of the disclosure;

FIG. 3A is a diagram of an example embodiment of the UE, connected devices and the network system, showing an example downlink communication according to one illustrated aspect of the disclosure;

FIG. 3B is a diagram of an example embodiment of the UE, connected devices and the network system, showing an example uplink communication according to one illustrated aspect of the disclosure;

FIG. 4 is a diagram of an example embodiment of the UE, connected devices and the network system, showing a combined downlink and uplink communication according to one illustrated aspect of the disclosure;

FIGS. 5A and 5B are diagrams of example signals and operations of a network system, according to one illustrated aspect of the disclosure;

FIGS. 6A and 6B are diagrams of example signals and operations of a network system, according to another illustrated aspect of the disclosure; and

FIG. 7 is a diagram of example embodiment of components of a UE, connected device or of a network apparatus, according to one illustrated aspect of the present disclosure.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX™), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, enhanced LTE (eLTE), 5G New Radio (5G NR), 5G Advance, 6G (and beyond) and 802.11ax (Wi-Fi™ 6), among other wireless networking systems. The term ‘eLTE’ here denotes the LTE evolution that connects to a 5G core. LTE is also known as evolved UMTS terrestrial radio access (EUTRA) or as evolved UMTS terrestrial radio access network (EUTRAN).

The present disclosure may use the term “serving network device” to refer to a network node or network device (or a portion thereof) that services a UE. As used herein, the terms “transmit to,” “receive from,” and “cooperate with,” (and their variations) include communications that may or may not involve communications through one or more intermediate devices or nodes. The term “acquire” (and its variations) includes acquiring in the first instance or reacquiring after the first instance. The term “connection” may mean a physical connection or a logical connection.

The present disclosure uses 5G NR as an example of a wireless network and may use smartphones and/or extended reality headsets as an example of UEs. It is intended and shall be understood that such examples are merely illustrative, and the present disclosure is applicable to other wireless networks and user equipment.

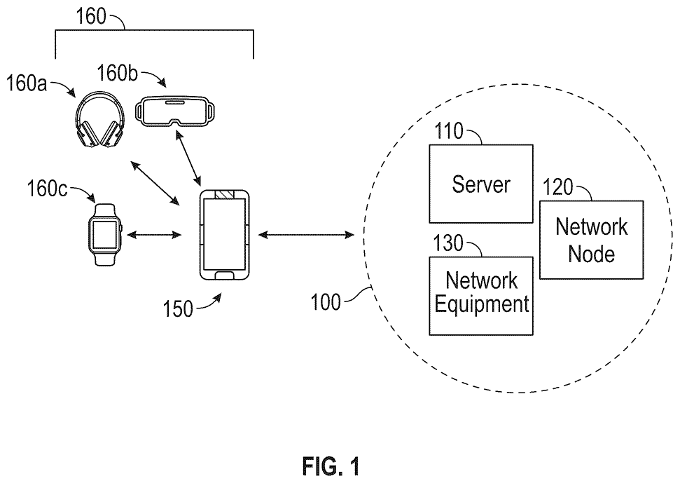

FIG. 1 is a diagram depicting an example of wireless networking between a network system 100 and a user equipment (UE) 150 that includes multiple devices 160 (designated 160a and 160b) connected to the UE 150. The devices 160 may be peripheral devices that are paired, or tethered, to the UE 150 via a wireless communication connection. For example, in various embodiments, the UE 150 and devices 160 may implement and be connected via a radio technology such as Institute of Electrical and Electronics Engineers (IEEE) 802.15 radio technology. However, one skilled in the art will understand that the devices 160 and UE 150 may be connected by other technologies.

Additionally, the devices 160 may include any type of device capable of being connected to the UE 150. For example, in various embodiments, the device 160a may be a headphone device, that may also include a microphone, connected to the UE 150 to facilitate the receiving and transmitting of audio data signals to and from the UE 150. Also, for example, the device 160b may be a video display and/or video imaging device (e.g., augmented reality (AR), virtual reality (VR), or mixed reality (MR) glasses) according to an example embodiment. Additionally, for example, the device 160c may be a smartwatch, that may include video display and/or audio playback capabilities, as well as video and/or audio capturing capabilities.

The network system 100 may include one or more network nodes 120, one or more servers 110, and/or one or more network equipment 130 (e.g., test equipment). The network nodes 120 will be described in more detail below. As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing aspects of 5G NR, among others. The present disclosure describes embodiments related to 5G NR and embodiments that involve aspects defined by 3rd Generation Partnership Project (3GPP). However, it is contemplated that embodiments relating to other wireless networking technologies are encompassed within the scope of the present disclosure.

The following description provides further details of examples of network nodes. In a 5G NR network, a gNodeB (also known as gNB) may include, e.g., a node that provides NR user plane and control plane protocol terminations towards the UE and that is connected via a NG interface to the 5G core (5GC), e.g., according to 3GPP TS 38.300 V16.6.0 (2021 June) section 3.2, which is hereby incorporated by reference herein.

A gNB supports various protocol layers, e.g., Layer 1 (L1)-physical layer, Layer 2 (L2), and Layer 3 (L3).

The layer 2 (L2) of NR is split into the following sublayers: Medium Access Control (MAC), Radio Link Control (RLC), Packet Data Convergence Protocol (PDCP) and Service Data Adaptation Protocol (SDAP), where, e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC quality of service (QOS) flows;
Control channels include broadcast control channel (BCCH) and physical control channel (PCCH).

Layer 3 (L3) includes, e.g., radio resource control (RRC), e.g., according to 3GPP TS 38.300 V16.6.0 (2021 June) section 6, which is hereby incorporated by reference herein.

A gNB central unit (gNB-CU) includes, e.g., a logical node hosting, e.g., radio resource control (RRC), service data adaptation protocol (SDAP), and packet data convergence protocol (PDCP) protocols of the gNB or RRC and PDCP protocols of the en-gNB, that controls the operation of one or more gNB distributed units (gNB-DUs). The gNB-CU terminates the F1 interface connected with the gNB-DU. A gNB-CU may also be referred to herein as a CU, a central unit, a centralized unit, or a control unit.

A gNB Distributed Unit (gNB-DU) includes, e.g., a logical node hosting, e.g., radio link control (RLC), media access control (MAC), and physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-DU may also be referred to herein as DU or a distributed unit.

As used herein, the term “network node” may refer to any of a gNB, a gNB-CU, or a gNB-DU, or any combination of them. A RAN (radio access network) node or network node such as, e.g., a gNB, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-) layer of a RAN (radio access network), e.g., layer 2 and/or layer 3. Different functional splits between the central and distributed unit are possible. An example of such an apparatus and components will be described in connection with FIG. 10 below.

The gNB-CU and gNB-DU parts may, e.g., be co-located or physically separated. The gNB-DU may even be split further, e.g., into two parts, e.g., one including processing equipment and one including an antenna. A central unit (CU) may also be called baseband unit/radio equipment controller/cloud-RAN/virtual-RAN (BBU/REC/C-RAN/V-RAN), open-RAN (O-RAN), or part thereof. A distributed unit (DU) may also be called remote radio head/remote radio unit/radio equipment/radio unit (RRH/RRU/RE/RU), or part thereof. Hereinafter, in various example embodiments of the present disclosure, a network node, which supports at least one of central unit functionality or a layer 3 protocol of a radio access network, may be, e.g., a gNB-CU. Similarly, a network node, which supports at least one of distributed unit functionality or a layer 2 protocol of the radio access network, may be, e.g., a gNB-DU.

A gNB-CU may support one or multiple gNB-DUs. A gNB-DU may support one or multiple cells and, thus, could support a serving cell for a user equipment (UE) or support a candidate cell for handover, dual connectivity, and/or carrier aggregation, among other procedures.

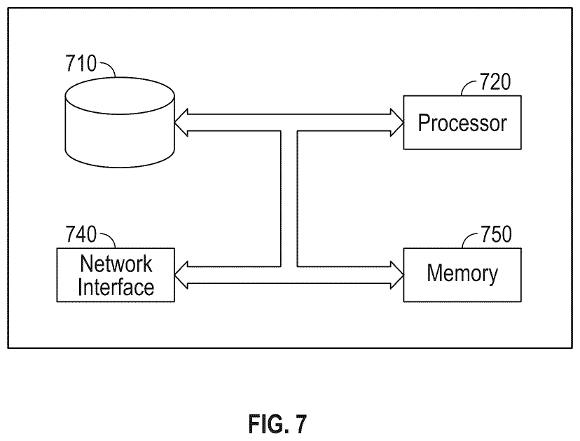

The user equipment (UE) 150 may be or include a wireless or mobile device, an apparatus with a radio interface to interact with a RAN (radio access network), a smartphone, an in-vehicle apparatus, an IoT device, or a M2M device, among other types of user equipment. Such UE 150 may include: at least one processor; and at least one memory including program code; where the at least one memory and the computer program code are configured to, with the at least one processor, cause the apparatus at least to perform certain operations, such as, e.g., RRC connection to the RAN. An example of components of a UE will be described in connection with FIG. 7. In embodiments, the UE 150 may be configured to generate a message (e.g., including a cell ID) to be transmitted via radio towards a RAN (e.g., to reach and communicate with a serving cell). In embodiments, the UE 150 may generate and transmit and receive RRC messages containing one or more RRC PDUs (packet data units). Persons skilled in the art will understand RRC protocol as well as other procedures a UE may perform.

With continuing reference to FIG. 1, in the example of a 5G NR network, the network system 100 provides one or more cells, which define a coverage area of the network system 100. As described above, the network system 100 may include a gNB of a 5G NR network or may include any other apparatus configured to control radio communication and manage radio resources within a cell. As used herein, the term “resource” may refer to radio resources, such as a resource block (RB), a physical resource block (PRB), a radio frame, a subframe, a time slot, a sub-band, a frequency region, a sub-carrier, a beam, etc. In embodiments, the network node 120 may be called a base station.

FIG. 1 provides an example and is merely illustrative of a network system 100 and a UE 150 that includes multiple devices 160 connected to the UE 150. Persons skilled in the art will understand that the network system 100 may include components not illustrated in FIG. 1 and will understand that other user equipment may be in communication with the network system 100. Also, the UE 150 may be in communication with more than two devices 160. In various embodiments, the connection between the UE 150 and the multiple connected devices 160 is wireless. The UE 150 serves as the central point of communication for all the connected devices 160. The UE 150 is the central point for providing tethering connection as well as for providing (e.g., audiostream data and videostream data) information. For example, the devices 160 do not directly connect to the network system 100 when the connection to the UE 150 is not possible.

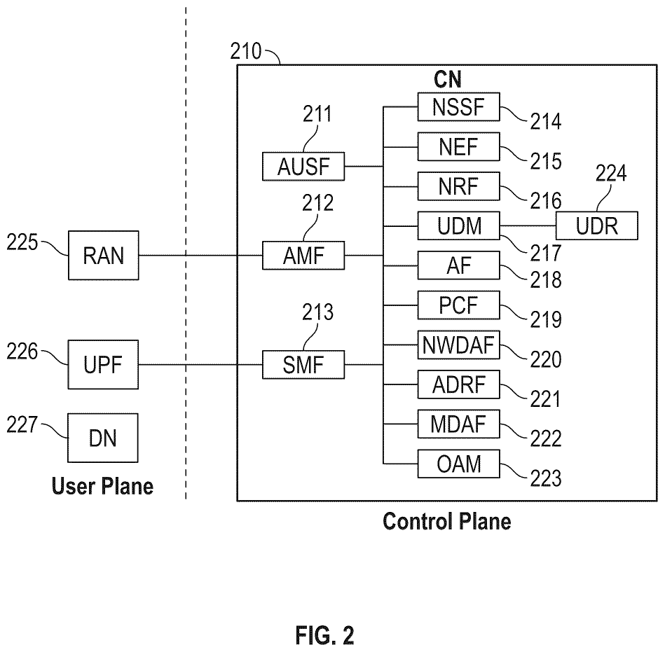

FIG. 2 is a block diagram of example components of the network system 100 of FIG. 1. A 5G NR network may be described as an example of the network system 100, and it is intended that aspects of the following description shall be applicable to other types of network systems, as well. The network system may operate in accordance with the signals and connections shown in FIG. 1 such that the UE 150 is in communication with the network system 100 through the radio access network 225. Additionally, the network system may be divided into user plane components and functions and control plane components and functions, as shown and described herein. Unless indicated otherwise, the terms “component”, “function”, and “service” may be used interchangeably herein, and they may refer to and be implemented by instructions executed by one or more processors.

Example functions of the components are described below. The example functions are merely illustrative, and it shall be understood that additional operations and functions may be performed by the components described herein. Additionally, the connections between components may be virtual connections over service-based interfaces such that any component may communicate with any other component. In this manner, any component may act as a service “producer,” for any other component that is a service “consumer,” to provide services for network functions.

For example, a core network 210 is described in the control plane of the network system. The core network 210 may include an authentication server function (AUSF) 211, an access and mobility function (AMF) 212, and a session management function (SMF) 213. The core network 210 may also include a network slice selection function (NSSF) 214, a network exposure function (NEF) 215, a network repository function (NRF) 216, and a unified data management function (UDM) 217, which may include a uniform data repository (UDR) 224.

Additional components and functions of the core network 210 may include an application function (AF) 218, policy control function (PCF) 219, network data analytics function (NWDAF) 220, analytics data repository function (ADRF) 221, management data analytics function (MDAF) 222, and operations and management function (OAM) 223.

The user plane includes the UE 150, a radio access network (RAN) 225, a user plane function (UPF) 226, and a data network (DN) 227. The RAN 225 may include one or more components described in connection with FIG. 1, such as one or more network nodes. However, the RAN 225 may not be limited to such components. The UPF 226 provides connection for data being transmitted over the RAN 225. The DN 226 identifies services from service providers, Internet access, and third party services, for example.

The AMF 212 processes connection and mobility tasks. The AUSF 211 receives authentication requests from the AMF 212 and interacts with UDM 217 to authenticate and validate network responses for determination of successful authentication. The SMF 213 conducts packet data unit (PDU) session management, as well as manages session context with the UPF 226.

The NSSF 214 may select a network slicing instance (NSI) and determine the allowed network slice selection assistance information (NSSAI). This selection and determination is utilized to set the AMF 212 to provide service to the UE 150. The NEF 215 secures access to network services for third parties to create specialized network services. The NRF 216 acts as a repository to store network functions to allow the functions to register with and discover each other.

The UDM 217 generates authentication vectors for use by the AUSF 211 and ADM 212 and provides user identification handling. The UDM 217 may be connected to the UDR 224 which stores data associated with authentication, applications, or the like. The AF 218 provides application services to a user (e.g., streaming services, etc.). The PCF 219 provides policy control functionality. For example, the PCF 219 may assist in network slicing and mobility management, as well as provide quality of service (QOS) and charging functionality.

The NWDAF 220 collects data (e.g., from the UE 150 and the network system) to perform network analytics and provide insight to functions that utilize the analytics in the providing of services. The ADRF 221 allows the storage, retrieval, and removal of data and analytics by consumers. The MDAF 222 provides additional data analytics services for network functions. The OAM 223 provides provisioning and management processing functions to manage elements in or connected to the network (e.g., UE 150, network nodes, etc.).

FIG. 2 is merely an example of components of a network system, and variations are contemplated to be within the scope of the present disclosure. In embodiments, the network system may include other components not illustrated in FIG. 2. In embodiments, the network system may not include every component illustrated in FIG. 2. In embodiments, the components and connections may be implemented with different connections than those illustrated in FIG. 2. Such and other embodiments are contemplated to be within the scope of the present disclosure.

As used herein, the term “signals” may refer to communication signals between the UE 150 and devices 160 as well as communication signals between the UE 150 and the network system 100. In addition, the term “signals” may refer to communication signals between components resident in a single device, such as signals between components resident with the UE 150, or signals between components resident in one of the devices 160. Persons skilled in the art will understand that the term “signals” may refer to additional communication signals between components of a single device/apparatus or between multiple devices/apparatuses and that signals may encompass a variety of example transmission techniques, including, but not limited to radio frequency (RF) signals, electrical signals, and/or electromagnetic (EM) radiation signals.

As used herein, the term “data” may refer to information carried in a signal or signals. The information may be encoded as digital information or analog information. In various example embodiments, the term “data” may refer to datastreams that may include media data. This may refer to video data (e.g., videostream data) and/or audio data (e.g., audiostream data) and/or other types of data. The terms “audiostream data” and “audio datastream” may be used interchangeably. The terms “videostream data” and “video datastream” may be used interchangeably. Persons skilled in the art will understand that “data” may refer to additional information that may be carried in a signal. For example, in various embodiments, the term “data” may refer to timing information for signals and/or synchronization information carried in one or more signals. As used herein, the term “synchronization” may refer to synchronization in time and/or in phase, unless indicated otherwise.

As used herein, the term “downlink” may refer to flow of information from a network system to a UE and then to multiple connected devices. The term “uplink” may refer to flow of information from multiple connected devices to a UE and then to a network system.

As used herein, a communication with a component of a network system (e.g., RAN of the network system) may refer to and mean a communication with a portion of a RAN, such as with a network node (e.g., a DU and/or a CU), or another portion of a RAN. As used herein, a communication with a core network may refer to and mean a communication with one or more services/applications of the core network, such as AMF or another service of a core network.

As described above and herein, and with continuing reference to FIG. 1, the UE 150 may receive communication signals from the network system 100 in the downlink and communication signals from any peripheral devices, such as devices 160 connected to it in the uplink. The signals received include data, such as videostream data and/or audiostream data. The data transmitted (or received) in one signal may not be synchronized in time with the data transmitted (or received) in another signal. For example, audiostream data transmitted (or received) between the UE 150 and the device 160a may not be synchronized in time with videostream data transmitted (or received) between the UE 150 and the device 160b. In some examples, the lack of synchronization may be caused by processing (queuing, buffering) delays and/or transmission delays in the devices 160, which may cause a signal from device 160a, for example, to be received by the UE 150 before or after a signal from another device 160b, for example. Further, although the description below describes various example operations between the UE 150 and device 160a and 160b, the operations apply to any connected devices 160 (e.g., device 160c).

For example, and in accordance with an example downlink embodiment, the UE 150 may receive a signal from the network system 100 that includes both videostream data and audiostream data. Upon transmission by the UE 150 of the audiostream data to device 160a (e.g., a headphone), for example, and the transmission of the videostream data to device 160b (e.g., a display device), a presentation of each of the data on the respective devices may not be synchronized in time with one another. As a result, the audio played by device 160a and the video displayed by device 160b will be out of synch. This out of synch condition may result from, for example, a difference in processing and transmission/receiving times between device 160a and UE 150 and between device 160b and UE 150, causing a time delay in presentation of the data by one device when compared to the other device. By synchronizing, in time, the data presentation in each of the devices 160a/160b, the quality of experience (QoE) may be enhanced for an end user of the devices.

In the example case where the UE 150 may be receiving a signal that includes audiostream data from device 160a and a signal that includes videostream data from device 160b, the data in the two signals may not be synchronized. Therefore, a resultant transmission of the data in the signals from the UE 150 to another entity, such as the network system 100 in the uplink direction, for example, may result in unsynchronized presentation. Synchronizing the audiostream data and the videostream data into a signal transmitted to the network system 100 by the UE 150 may result in increased QoE for a user displaying the data contained in the signal.

Accordingly, described herein are example techniques for synchronizing data in time for presentation. In one example embodiment, the synchronization includes synchronizing data received in a signal by the UE 150 from the network system 100 for transmitting to devices 160, which may be referred to as a “downlink” transmission direction, as mentioned above.

In another example embodiment, the synchronization includes receiving data, which in an example may be referred to as “first data”, from the device 160a, and receiving data, which in an example may be referred to as “second data”, from the device 160b. A resultant signal may be generated by the UE 150 that includes the first data and second data synchronized for transmission to the network system 100. This example technique may be referred to as an “uplink” transmission direction, as mentioned above.

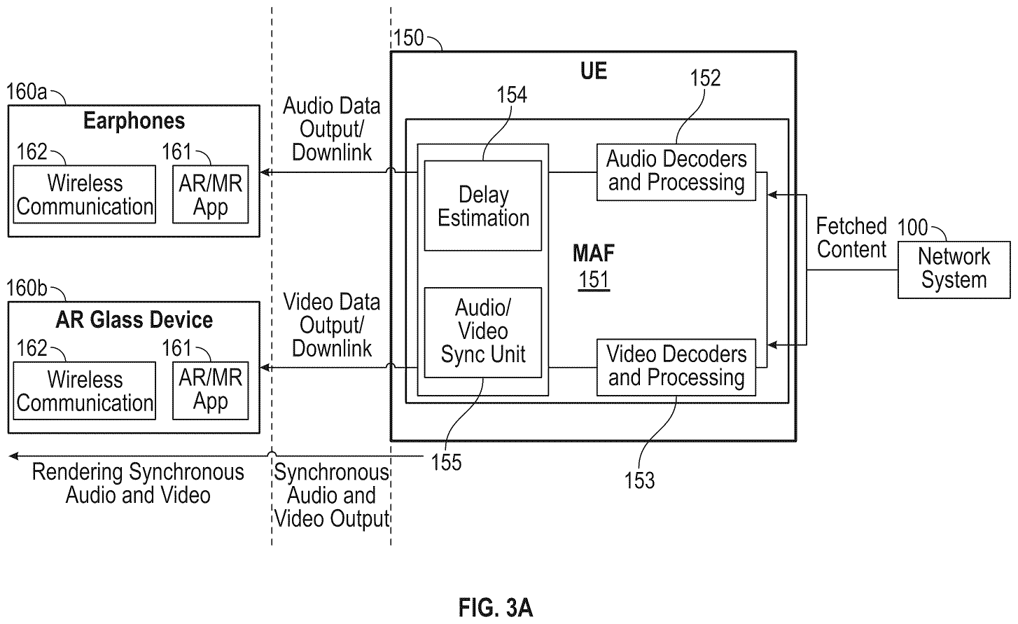

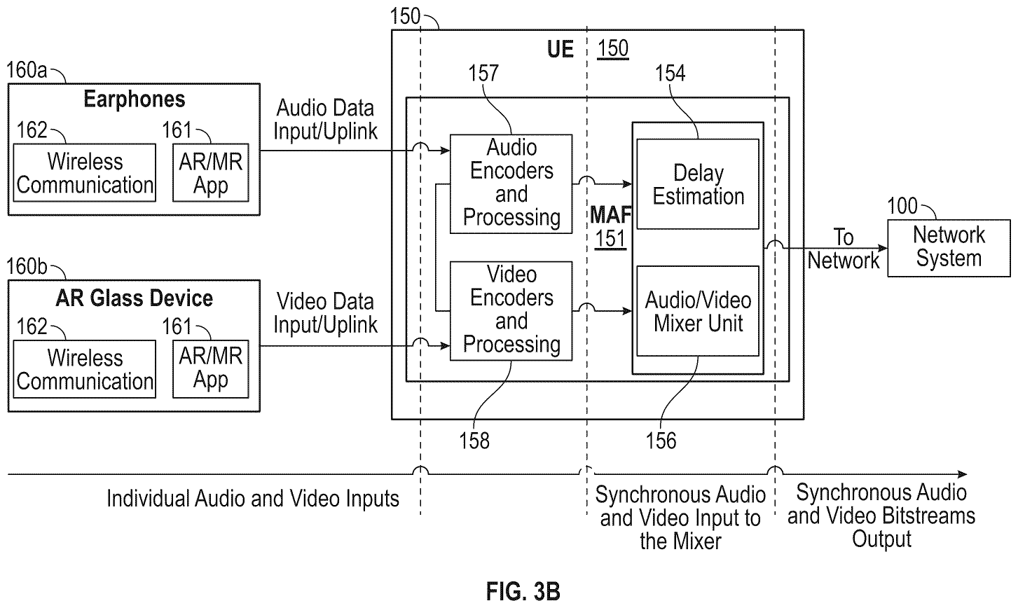

FIG. 3A is a diagram of an example embodiment of the UE 150, connected devices 160 and the network system 100, showing an example downlink communication according to one illustrated aspect of the disclosure. As shown in FIG. 3A, UE 150 includes a media access function (MAF) 151. The MAF 151 in the UE 150 provides processing for media received and/or transmitted by the UE 150. The MAF 151, as shown in FIG. 3A, includes, at least, audio decoders and processing function 152, video decoders and processing function 153, a delay estimation function 154 and an audio/video sync unit function 155. In an example embodiment, the delay estimation function 154 and the audio/video sync unit function 155 may reside in or on a submodule within the MAF 151. Persons skilled in the art will understand that other functions may be included in the MAF 151. The audio decoders and processing function 152, video decoders and processing function 153, delay estimation function 154 and audio/video sync unit function 155 may be operatively coupled with, and in communication with, one another to share signals and information with one another.

The audio decoders and processing function 152 performs decoding of audio datastreams in a signal by the UE 150. In some embodiments, the audio data in an audio datastream may be compressed in order to facilitate transmission of the data. Accordingly, the audio decoders and processing function 152 may decompress the audio data in the signal received by the UE 150.

Similarly, the video decoders and processing function 153 performs decoding of video datastreams in a signal by the UE 150. In some embodiments, the video data in video datastream may be compressed in order to facilitate transmission of the data. Accordingly, the video decoders and processing function 153 may decompress the video data in the signal by the UE 150.

In FIG. 3A, the delay estimation function 154 performs estimation of one or more downlink delays between the UE 150 and devices 160 connected to the UE 150. In various embodiments, the delay estimation may include an estimation of the processing delay in and transmission delay to each device 160, such as devices 160a and 160b. Such delays may reflect the time delay between the UE 150 transmitting data and a device (160a or 160b) presenting the data to a user. In an example embodiment, the delay estimation may include the use of a round trip time (RTT) delay estimation technique, which would be familiar to a person skilled in the art. In some examples, RTT delay estimation may include the use of Internet Control Message Protocol (ICMP) protocol, using, for example, RFC792 message format, and/or Real-Time Transport Protocol/Real-Time Control Protocol (RTP/RTCP) using, for example, RFC3550 message format. The estimation of the delay by the delay estimation function 154 of the MAF 151 allows the MAF 151 to determine a communication latency between the UE 150 and each device 160. Persons skilled in the art will understand that additional delay measurements may be utilized and additional techniques for estimating delay may be employed in the delay estimation function 154.

The audio/video sync unit function 155 configures the data transmissions to the devices 160 such that the data presentations of the devices 160 are synchronized in time and/or phase or approximately synchronized in time and/or phase. In various embodiments, for example, the audio/video sync unit function 155 may synchronize, in time, audiostream data (e.g., first data) in a signal for transmission to the device 160a with videostream data (e.g., second data) in a signal for transmission to the device 160b. The audio/video sync unit function 155 in some embodiments may utilize the delay for each device 160, as determined by the delay estimation function 154, in order to synchronize, in time, the presentation of the data to a user of device 160a with the presentation of the data to a user of the device 160b. In some embodiments, the user of devices 160a and 160b may be the same user. Accordingly, the audio/video sync unit function 155 enables a user of device 160a and 160b to perceive the presentation of the data by both devices as a synchronized presentation.

The audio/video sync unit function 150 is merely an example of a synchronization function. In general, the synchronization function operates to configure the downlink transmissions such that data is presented by the devices in time synchronization or in approximate time synchronization. In various embodiments, synchronization unit may not be able to perfectly synchronize the presentations in time because of, e.g., changing transmission delays to the devices 160 and/or changing processing demands at the devices 160, changing positions of devices 160, among other factors. However, the synchronization function may be able to approximately synchronize the data presentations such that one or more users still perceive the presentations as synchronized in time. Accordingly, as used herein, the term “approximately synchronized” (and its variations) refers to and means that a synchronization that may not be perfect but may still be perceived by one or more users as synchronized in time. The following description will continue to describe audio and video synchronization as an example. However, it is intended that any description of audio and video synchronization shall be treated as though the description refers to synchronization of any data types. In an example embodiment, IEEE 1588-2002, IEEE 1588-2008, IEEE 1588-2019 types protocols may be used inside the synchronization function.

Further, as shown in FIG. 3A, the device 160a may, in some embodiments, be a set of wireless earphones and may also include a device for receiving audio input data (e.g., a microphone). The device 160b, in some embodiments, may include a wireless device for displaying video data (e.g., AR glasses), and may also in some embodiments include a device for capturing images (e.g., a camera). Both devices 160 may include an AR/MR application 161 for processing data (e.g., encoding/decoding) and a wireless communication function 162 for facilitating transmission and reception of wireless signals and is at the same time used in the process of tethering. Persons of skill in the art will understand that the components shown in the device 160 are examples only, and that other components and functions may be present in the devices 160.

The example operation shown in FIG. 3A may be referred to as the downlink direction, as described above. For example, as shown in FIG. 3A, the UE 150 may be in communication with the network system 100 and may receive a signal from the network system 100 (e.g., a signal including fetched content). In some embodiments, the fetched content may include streaming data such as live streaming data or on-demand data. In other example embodiments, the fetched content may be downlink information received during a videoconference and/or audioconference. In some examples, the fetched content may include videostream data and audiostream data.

Upon receipt of the fetched content by the UE 150 from the network system 100, the audio decoders and processing function 152 performs decoding and processing of the audiostream data in the fetched content. In some embodiments, the audio decoders and processing function 152 may extract the audiostream data from the fetched content for decoding/processing. Additionally, in some examples, the video decoders and processing function 153 performs decoding and processing of the videostream data in the fetched content. In some embodiments, the video decoders and processing function 153 may extract the videostream data from the fetched content for decoding/processing.

In some examples, the audio/video sync unit function 155, with information relating to the delay for devices 160a and 160b determined by the delay estimation function 154, receives the decoded/processed audiostream data from the audio decoders and processing function 152 and the decoded/processed videostream data from the video decoders and processing function 153. The audio/video sync unit function 155 generates a signal including the audiostream data for transmission to the device 160a based upon the determined delay for the device 160a and generates a signal including the videostream data for transmission to the device 160b based upon the delay for the device 160b. The delay in various embodiments may include a transmission delay and/or a processing delay. For example, the delay may include the transmission delay for propagation of a signal to a respective device 160 and/or may also include a delay due to the processing delay in the respective device 160.

In some embodiments, the transmission of the signal including the audiostream data (audio data output/downlink signal) to device 160a may be transmitted at a first time, and the transmission of the signal including the videostream data (video data output/downlink signal) to device 160b may be transmitted at a second time. For example, the transmission of the audio data output/downlink signal may be transmitted after a time delay. In some examples, the delay may be encoded in the audio data output/downlink signal and the video data output/downlink signal. For example, one or both of the audio data output/downlink signal and video data output/downlink signal may include data that provides information to indicate to the respective device 160 a time to present the data. For example, the video data output/downlink signal may include information indicating a start time at time=0 (t₀), while the audio data output/downlink signal may include information indicating a start time of time=1 (t₁). In this case, the device 160b may present (e.g., render video data) at time to while the device 160a presents its data (e.g., plays audio) at time t₁. The values t0 and t1 are the delay that may include the transmission delay for propagation of a signal to a respective device 160 and/or may also include a delay due to the processing delay in the respective device 160.

Accordingly, the example downlink operation shown in FIG. 3A provides for a signal received by the UE 150 from the network system 100 to be split into two component signals (e.g., audiostream data and videostream data signals). The two signals are synchronized in time by the audio/video sync unit function 155 and provide synchronous data output for eventual synchronous presentation and/or perception by a user or users, such as synchronous audio and video rendering and/or reproduction.

The following describes various operations of FIG. 3A from the perspective of the UE 150. The operations include receiving, by the UE, a first signal (e.g., fetched content) from a first apparatus (e.g., network system 100), the first signal including a first data (e.g., audiostream data) for presentation by a second apparatus (e.g., device 160a) in communication with the UE and a second data (e.g., videostream data) for presentation by a third apparatus (e.g., device 160b) in communication with the UE, the first data and the second data being synchronized with each other in time; extracting, by the UE, the first data from the first signal; extracting, by the UE, the second data from the first signal; determining a timing for transmitting a second signal (e.g., audio data output/downlink) that comprises the first data to the second apparatus and for transmitting a third signal (e.g., video data output/downlink) that includes the second data to the third apparatus, the timing configured to approximately synchronize in time presentation of the first data by the second apparatus and presentation of the second data by the third apparatus; transmitting the second signal to the second apparatus based on the timing; and transmitting the third signal to the third apparatus based on the timing.

The following describes additional various operations of FIG. 3A from the perspective of the UE 150. The operations include receiving, by the UE, a first signal (e.g., fetched content) from a first apparatus (e.g., network system 100), the first signal including first data (e.g., audiostream data) for presentation by a second apparatus (e.g., device 160a) in communication with the UE and second data (e.g., videostream data) for presentation by a third apparatus (e.g., device 160b) in communication with the UE, the first data and the second data being synchronized with each other in time; extracting, by the UE, the first data from the first signal; extracting, by the UE, the second data from the first signal; determining, by the UE, a timing for presentation of the first data by the second apparatus and presentation of the second data by the third apparatus, the timing configured to approximately synchronize in time presentation of the first data by the second apparatus and presentation of the second data by the third apparatus; transmitting, by the UE, a second signal (e.g., audio data output/downlink) that comprises the first data to the second apparatus; and transmitting, by the UE, a third signal (e.g., video data output/downlink) that comprises the second data to the third apparatus, wherein at least one of the second signal or the third signal comprises an encoded presentation delay based on the timing.

In some example embodiments, signals may be received from the devices 160 by the UE 150 for transmission to the network system 100. FIG. 3B is a diagram of an example embodiment of the UE 150, connected devices 160 and the network system 100, showing an example uplink communication according to one illustrated aspect of the disclosure. Similar to FIG. 3A, the UE 150 includes a media access function (MAF) 151. The MAF 151 in the UE 150 provides processing for media received and/or transmitted by the UE 150. The MAF 151 shown in FIG. 3B includes, at least, a delay estimation function 154, an audio/video mixer unit function 156, an audio encoders and processing function 157, and a video encoders and processing function 158. In an example embodiment, the delay estimation function 154 and the audio/video mixer unit function 156 may reside in or on a submodule within the MAF 151, and in some embodiments on the same submodule as the audio/video sync unit function 155 shown in FIG. 3A. Persons skilled in the art will understand that other functions may be included in the MAF 151. The delay estimation function 154, audio/video mixer unit function 156, audio encoders and processing function 157, and video encoders and processing function 158 may be operatively coupled with, and in communication with one another to share signals and information with one another.

The audio encoders and processing function 157 performs encoding of audio datastreams in a signal by the UE 150. In some embodiments, the audio data in an audio datastream may be compressed in order to facilitate transmission of the data. Accordingly, the audio encoders and processing function 157 may compress the audio data in the signal received by the UE 150 from the device 160a.

Similarly, the video encoders and processing function 158 performs encoding of video datastreams in a signal by the UE 150. In some embodiments, the video data in video datastream may be compressed in order to facilitate transmission of the data. Accordingly, the video encoders and processing function 158 may compress the video data in the signal by the UE 150 from the device 160b.

Similar to the delay estimation function 154, the delay estimation function 154 performs estimation of one or more delays between the UE 150 and devices 160 connected to the UE 150. In various embodiments, the delay estimation may be performed similarly to the delay estimation described above in FIG. 3A. Persons skilled in the art will understand that additional delay measurements may be utilized and additional techniques for estimating delay may be employed in the delay estimation function 154.

The audio/video mixer unit function 156 synchronizes, in time, data received by the UE 150 from devices 160 for transmission in a signal to the network system 100. In various embodiments, for example, the audio/video sync unit function 156 may synchronize, in time, audiostream data (e.g., first data) received from device 160a with videostream data (e.g., second data) received from device 160b in a signal for transmission to the network system 100. The audio/video sync mixer function 156, in some embodiments, may utilize the delay for each device 160 as determined by the delay estimation function 154 in order to synchronize the first data and second data in a common signal to be transmitted to the network system 100. That is, the audio/video mixer unit function 156 may mix, for example, audio data and video data into a single audio/video signal. In example embodiments, the audio datastreams and video datastreams may be identified using the header information used in the Real-time Transport Protocol (RTP) IETF RFC 3550 or Real-time Streaming Protocols (RTSP) IETF RFC 2326, by which audio signals and video signals are sent by different channels with the identifiers in their respective header information, as would be understood by a person skilled in the art.

In some examples, the audio data transmission frequency is high, and the data packets may be relatively small, while the video data transmission frequency is lower and the data packets may be larger than audio packets. Accordingly, in some embodiments, the audio/video mixer unit function 156 may generate a signal for transmission by mixing the packets in accordance with the received timestamps information, and synchronize in time the audio data packets with the respective video data packets based upon the delay information received from the delay estimation function 154. Accordingly, the audio/video mixer unit function 156 creates a synchronous audiostream/videostream data for transmission to the network system 100.

The devices 160a and 160b may be similar to the devices 160a and 160b described above in FIG. 3A.

The example operation shown in FIG. 3B may be referred to as the uplink direction, as described above. For example, as shown in FIG. 3B, the UE 150 may be in communication with the device 160a and may receive an audio data signal (e.g., audio data input/uplink signal) that contains audiostream data. Additionally, the UE 150 may be in communication with the device 160b and may receive a video data signal (e.g., video data input/uplink signal) that contains videostream data. The audio data in the audio data signal may be audio data that is captured by, for example, the microphone of device 160a, while the video data in the video data signal may be captured by, for example, an image capturing device of the device 160b.

Upon receipt of the audio data signal by the UE 150 from the device 160a, the audio encoders and processing function 157 performs encoding and processing of the audiostream data. Additionally, in some examples, the video encoders and processing function 158 performs encoding and processing of the videostream data.

In some examples, the audio/video sync mixer function 156, with information relating to the delay for devices 160a and 160b determined by the delay estimation function 154, receives the encoded/processed audiostream data from the audio encoders and processing function 157 and the encoded/processed videostream data from the video encoders and processing function 158. The audio/video mixer unit function 156 generates a signal that includes both the audiostream data and the videostream data synchronized for transmission to the network system 100 based upon the determined delay for the device 160a and the delay for the device 160b.

The delay in various embodiments may include a transmission delay and/or a processing delay. For example, the delay may include the transmission delay for propagation of a signal to a respective device 160 and/or may also include a delay due to the processing delay in the respective device 160. For example, where the audiostream data is received from device 160a at time=0 (t₀) and the corresponding videostream data is received from device 160b at time=1 (t₁), the audio/video sync mixer function 156 may synchronize both the audiostream data and the videostream data to begin at the same time in the combined signal to be transmitted to the network system 100. The audio/video sync mixer function is merely an example. In general, a mixer function may mix multiple data of any type and synchronize them in time.

Accordingly, the example uplink operation shown in FIG. 3B provides for signals received by the UE 150 at different times from the devices 160a and 160b to be combined into one signal as synchronized data for transmission to the network system 100.

The following describes various operations of FIG. 3B from the perspective of the UE 150. The operations include receiving, by the UE, a first signal (e.g., audio data input/uplink) including first data (e.g., audiostream data) from a first apparatus (e.g., device 160) in communication with the UE; receiving, by the UE, a second signal (e.g., video data input/uplink) comprising second data (e.g., videostream data) from a second apparatus (e.g., device 160b) in communication with the UE; determining, by the UE, a timing which synchronizes the first data and the second data in time; generating, by the UE and based on the timing, a third signal (e.g., to network) including the first data and the second data, the first data and the second data being synchronized in time in the third signal; and transmitting the third signal to a third apparatus (e.g., network system 100).

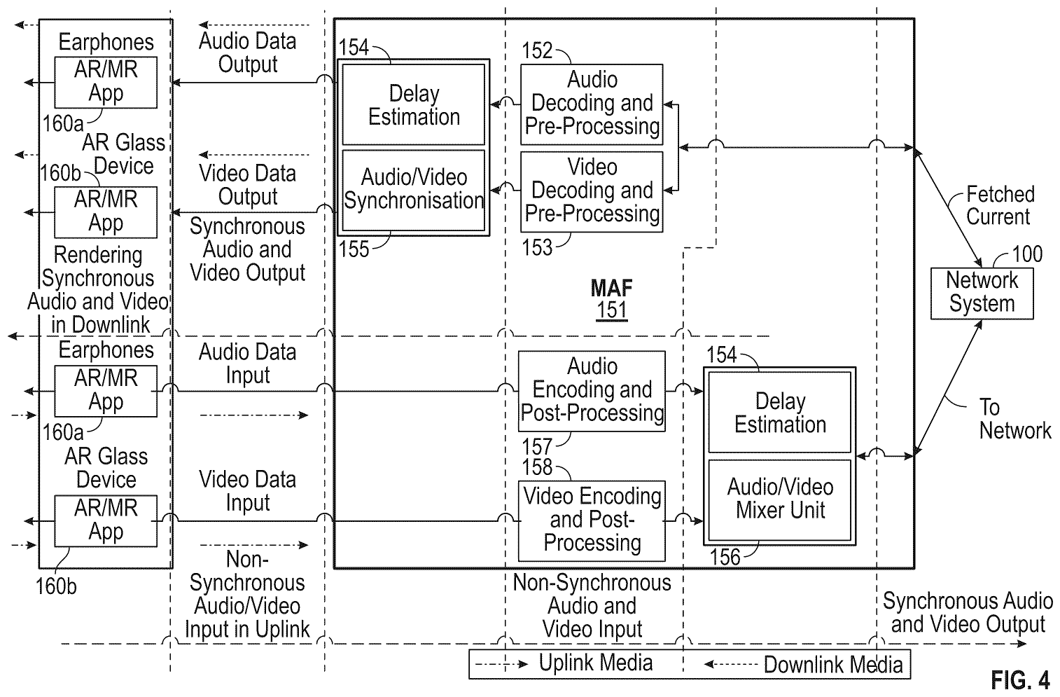

FIG. 4 is a diagram of an example embodiment of the UE 150, connected devices 160 and the network system 100, showing a combined downlink and uplink communication according to one illustrated aspect of the disclosure. The components and operations shown in FIG. 4 are similar to those described above in FIGS. 3A and 3B, but show various components combined in the MAF 151.

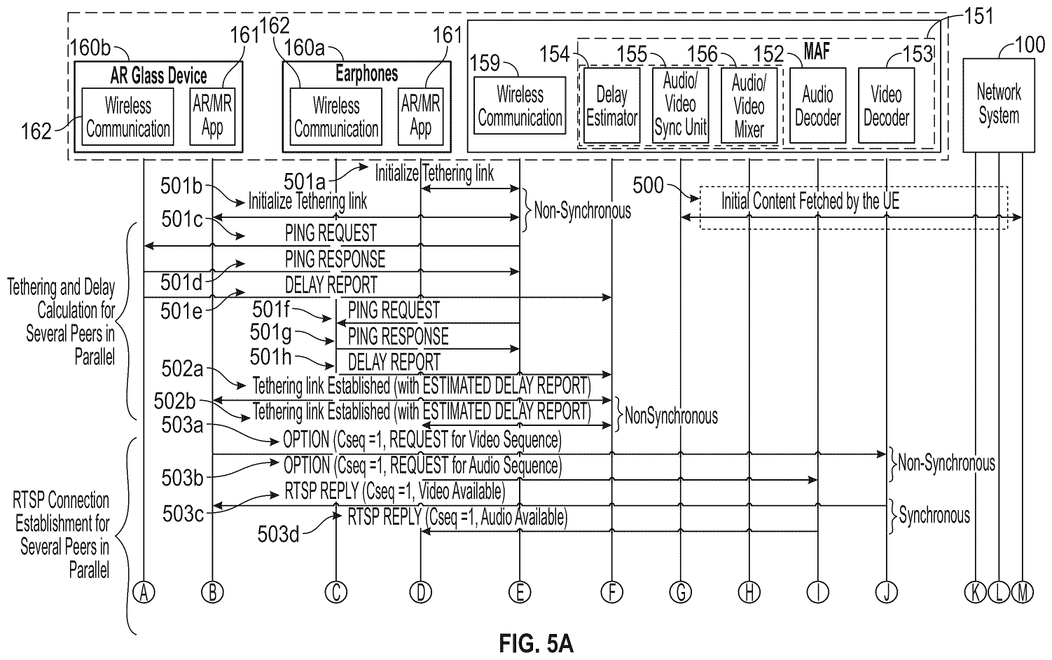

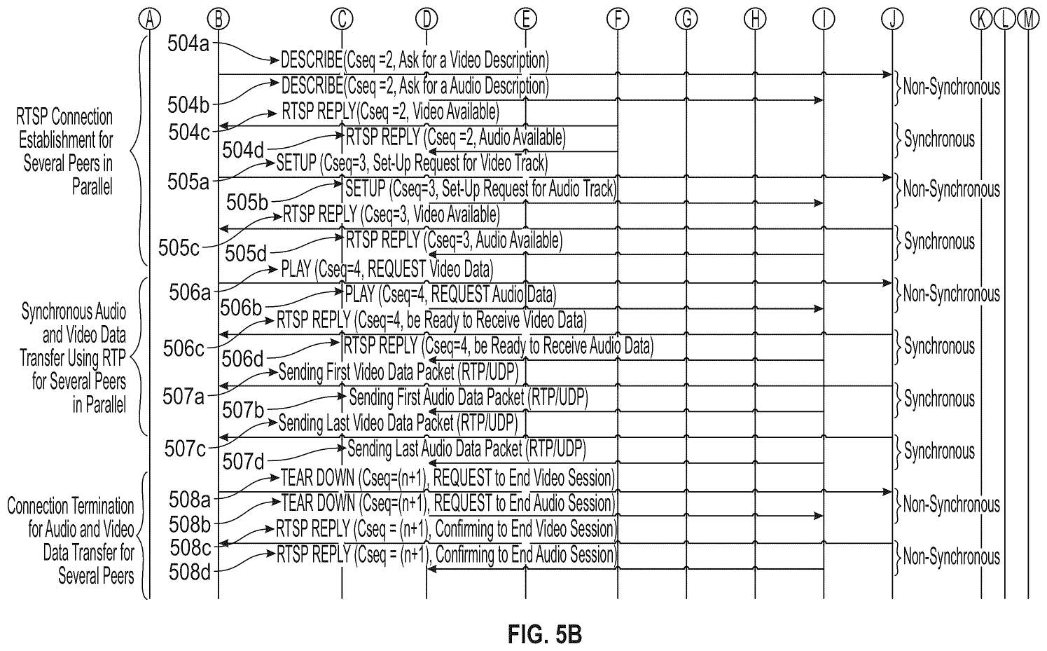

FIGS. 5A and 5B are a diagram of example signals and operations of a network system, according to one illustrated aspect of the disclosure. The following paragraphs will describe various signals and operations. It will be understood that a described signal may have associated operations and a described operation may have associated signals. The example signals and operations shown in FIGS. 5A and 5B depict an example downlink direction communication as described above.

At operation 500, initial content may be fetched by the UE 150 from the network system 100. For example, the UE 150, via a wireless communication function 159 for example, may receive a signal that includes audiostream data and videostream data at operation 500.

At operation 501a, a tethering link is initialized between the UE 150 and the device 160a. At operation 501b, a tethering link is initialized between the UE 150 and the device 160b. In some examples, operations 501a and 501b may be performed non-synchronously, e.g., the operations are not coordinated in time.

At operation 501c, the UE 150 transmits a ping request to the device 160b, and the device 160b receives the ping request. In response, at operation 501d, the device 160b transmits a ping response to the UE 150, and the UE 150 receives the ping response. The device 160b transmits a delay report at operation 501e to the UE 150, and the UE 150 receives the delay report. The delay report may include information regarding processing delays, such as queueing and buffering delays, for example, among other possible processing delays.

At operation 501f, the UE 150 transmits a ping request to the device 160a, and the device 160a receives the ping request. In response, at operation 501g, the device 160a transmits a ping response to the UE 150, and the UE 150 receives the ping response. The device 160a transmits a delay report at operation 501h to the UE 150, and the UE 150 receives the delay report. The delay report may include information regarding processing delays, such as queueing and buffering delays, for example, among other possible processing delays.

At operation 502a, a tethering link is established, between the UE 150 and the device 160b, that may include an estimated delay report that estimates one or more delays between the UE 150 and the device 160b, such as the transmission delay and processor delay described above herein. At operation 502b, a tethering link is established, between the UE 150 and the device 160a, that may include an estimated delay report that estimates one or more delays between the UE 150 and the device 160a, such as the transmission delay and processor delay described above herein. In some examples, operations 502a and 502b may be performed non-synchronously, e.g., the operations are not coordinated in time and/or phase. Collectively, operations 501a-502b may encompass the tethering and delay calculations/estimations for several peer devices (e.g., 160a/160b) connected in parallel to the UE 150.

Further, with respect to operations 503a-507d, as explained in additional detail below, upon establishment of tethering between the devices 160a/160b and the UE 150, operations relating to signals or messages received by the UE 150 from either the device 160a or 160b may be non-synchronous (e.g., not coordinated in time), while operations relating to signals or messages transmitted from the UE 150 to devices 160a and 160b may be synchronized with one another (e.g., coordinated in time).

Referring now to operations 503a-505d, these operations may collectively encompass a Real Time Streaming Protocol (RTSP) establishment for the several peer devices (e.g., 160a/160b) connected in parallel to the UE 150. In various example embodiments, the RTSP performs the establishment and control for media sessions between a transmitting device for media (e.g., videostream data/audiostream data) and a device that receives the media.

At operation 503a, a request for a video sequence message is transmitted from the device 160b, and the UE 150 receives the request for a video sequence message. At operation 503b, a request for an audio sequence message is transmitted from the device 160a, and the UE 150 receives the request for an audio sequence message. The UE 150 replies to the request for a video sequence message at operation 503c with a video available message that is received by the device 160b. The UE 150 replies to the request for an audio sequence message at operation 503d with an audio available message that is received by the device 160a.

At operation 504a, a request (ask) for a video description message is transmitted from the device 160b, and the UE 150 receives the request for a video description message. At operation 504b, a request (ask) for an audio description message is transmitted from the device 160a, and the UE 150 receives the request for an audio sequence message. The UE 150 replies to the request for a video description message at operation 504c with a video available message that is received by the device 160b. The UE 150 replies to the request for an audio description message at operation 504d with an audio available message that is received by the device 160a.

At operation 505a, a set-up request for video track message is transmitted from the device 160b, and the UE 150 receives the set-up request for a video track message. At operation 505b, a set-up request for audio track message is transmitted from the device 160a, and the UE 150 receives the request for audio track message. The UE 150 replies to the set-up request for video track message at operation 505c with a video available message that is received by the device 160b. The UE 150 replies to the set-up request for audio track message at operation 505d with an audio available message that is received by the device 160a.

Once the RTSP connection is established, operations 506a-507d may be directed to the transfer of synchronous audio and video data using RTP protocols described above and/or User Data Protocol (UDP). For example, at operation 506a, the device 160b transmits a request video data message to the UE 150, and the UE 150 receives the request video data message. At operation 506b, the device 160a transmits a request audio data message to the UE 150, and the UE 150 receives the request audio data message. In response to the UE 150 receiving the request video data message, the UE 150 at operation 506c transmits a “be ready to receive” message to the device 160b, and the device 160b receives the “be ready to receive” message. In response to receiving the request audio data message, the UE 150 at operation 506c transmits a “be ready to receive” message to the device 160a, and the device 160a receives the “be ready to receive” message.

Once the UE 150 has transmitted the “be ready to receive” messages (e.g., at operations 506c and 506d) to the respective device 160, the UE 150 transmits video and audio data to the devices. In various embodiments, the transmitted video and audio data may be transmitted in accordance with the techniques described above, such as in FIG. 3A. For example, at operation 507a, the UE 150 transmits the first video data packet to the device 160b, and the device 160b receives the first data packet. At operation 507b, the UE 150 transmits the first audio data packet to the device 160a, and the device 160a receives the first audio packet. Although not shown in FIGS. 5A and 5B, the UE 150 then continues to transmit subsequent video packets to the device 160b, and the device 160b continues to receive subsequent video packets. The UE 150 also continues to transmit subsequent audio packets to the device 160a, and the device 160a continues to receive subsequent audio packets. The transmission of subsequent video packets and audio packets continues until the UE 150 transmits the last video packet and last audio packet as shown in operations 507c-507d.

At operation 507c, the UE 150 transmits the last video data packet to the device 160b, and the device 160b receives the last data packet. At operation 507d, the UE 150 transmits the last audio data packet to the device 160a, and the device 160a receives the last audio packet.

Once the last video data packet is received by the device 160b and the last audio data packet is received by the device 160a, the connection for audio and video data between devices 160 and the UE 150 may be terminated at operations 508a-508d. In various example embodiments, the operations and signals at operations 508a-508d may be non-synchronous.

At operation 508a, the device 160b transmits a “request to end video session” message to the UE 150, and the UE 150 receives the “request to end video session” message. At operation 508b, the device 160a transmits a “request to end audio session” message to the UE 150, and the UE 150 receives the “request to end audio session” message. In response to receiving the “request to end video session” message, at operation 508c, the UE 150 transmits a “confirming to end video session” message to the device 160b, and the device 160b receives the “confirming to end video session” message. In response to receiving the “request to end audio session” message, at operation 508d, the UE 150 transmits a “confirming to end audio session” message to the device 160a, and the device 160a receives the “confirming to end audio session” message.

The signals and operations of FIGS. 5A and 5B are merely illustrative, and variations are contemplated to be within the scope of the present disclosure. In embodiments, the signals and operations may include others not illustrated in FIG. 5A or FIG. 5B. In embodiments, the signals and operations may not include every signal and operation illustrated in FIG. 5A and FIG. 5B. In embodiments, the signals and operations may be implemented in a different order than that illustrated in FIG. 5A and FIG. 5B. Such and other embodiments are contemplated to be within the scope of the present disclosure.

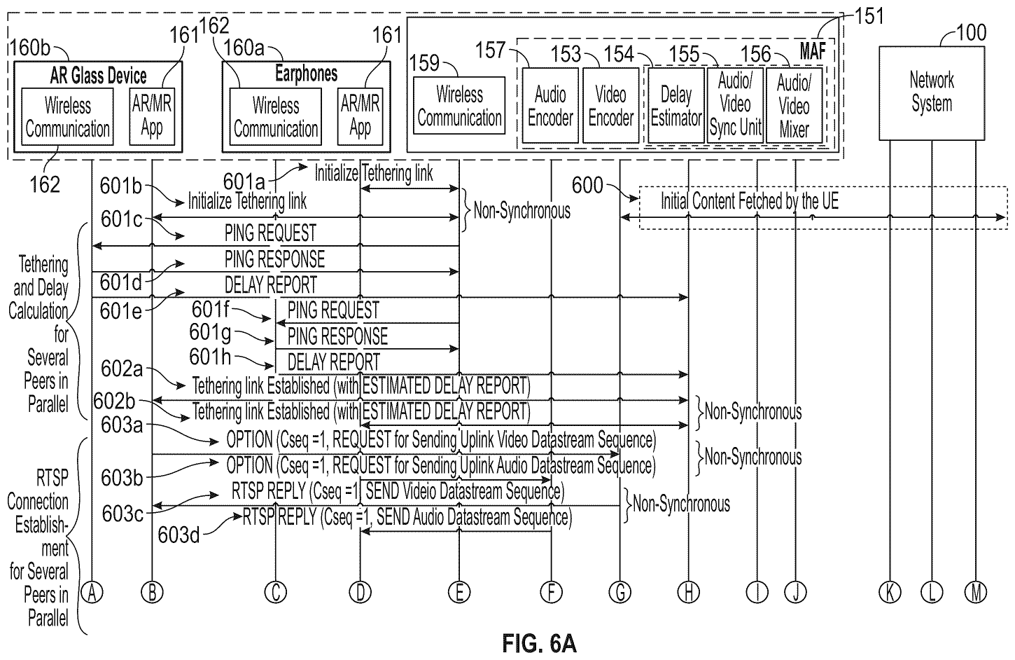

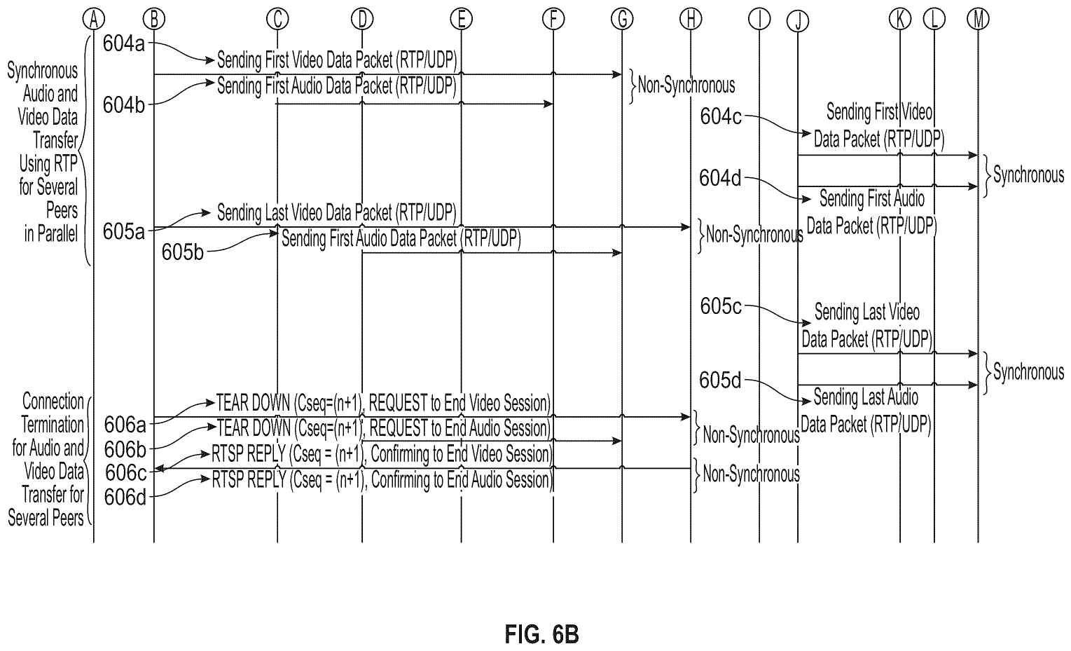

In the manner described in connection with FIG. 3A and FIGS. 5A and 5B, a UE times transmissions of synchronous data to devices connected to the UE so that the presentations of the data by the devices are synchronized in time and/or phase or approximately synchronized in time and/or phase. In the manner described in FIG. 3B and FIGS. 6A and 6B below, a UE receives multiple non-synchronous data communications from multiple connected devices and transmits a communication signal that includes synchronized data received from the multiple connected devices.

FIGS. 6A and 6B are a diagram of example signals and operations of a network system, according to one illustrated aspect of the disclosure. The following paragraphs will describe various signals and operations. It will be understood that a described signal may have associated operations and a described operation may have associated signals. The example signals and operations shown in FIGS. 6A and 6B depict an example uplink direction communication as described above.

At operation 600, initial content may be fetched by the UE 150 from the network system 100. For example, the UE 150, via a wireless communication function 159 for example, may receive a signal that includes audiostream data and videostream data or a request for audiostream and videostream data at operation 600.

At operation 601a, a tethering link is initialized between the UE 150 and the device 160a. At operation 601b, a tethering link is initialized between the UE 150 and the device 160b. In some examples, operations 601a and 601b may be performed non-synchronously, e.g., the operations are not coordinated in time.

At operation 601c, the UE 150 transmits a ping request to the device 160b, and the device 160b receives the ping request. In response, at operation 601d, the device 160b transmits a ping response to the UE 150, and the UE 150 receives the ping response. The device 160b transmits a delay report at operation 601e to the UE 150, and the UE 150 receives the delay report. The delay report may include information regarding processing delays, such as queueing and buffering delays, for example, among other possible processing delays.

At operation 601f, the UE 150 transmits a ping request to the device 160a, and the device 160a receives the ping request. In response, at operation 601g, the device 160a transmits a ping response to the UE 150, and the UE 150 receives the ping response. The device 160a transmits a delay report at operation 601h to the UE 150, and the UE 150 receives the delay report. The delay report may include information regarding processing delays, such as queueing and buffering delays, for example, among other possible processing delays.

At operation 602a, a tethering link is established, between the UE 150 and the device 160b, that may include an estimated delay report that estimates one or more delays between the UE 150 and the device 160b, such as the transmission delay and processor delay described above herein. At operation 602b, a tethering link is established, between the UE 150 and the device 160a, that may include an estimated delay report that estimates one or more delays between the UE 150 and the device 160a, such as the transmission delay and processor delay described above herein. In some examples, operations 602a and 602b may be performed non-synchronously, e.g., the operations are not coordinated in time and/or phase. Collectively, operations 601a-602b may encompass the tethering and delay calculations/estimations for several peer devices (e.g., 160a/160b) connected in parallel to the UE 150.

Further, with respect to operations 603a-605d, as explained in additional detail below, upon establishment of tethering between the devices 160a/160b and the UE 150, operations relating to signals or messages received by the UE 150 from either the device 160a or 160b may be non-synchronous (e.g., not coordinated in time and/or phase), while operations relating to signals or messages transmitted from the UE 150 to the network system 100 may be synchronized with one another (e.g., coordinated in time and/or phase).

Referring now to operations 603a-603d, these operations may collectively encompass a Real Time Streaming Protocol (RTSP) establishment for the several peer devices (e.g., 160a/160b) connected in parallel to the UE 150. In various example embodiments, the RTSP performs the establishment and control for media sessions between a transmitting device for media (e.g., videostream data/audiostream data) and a device that receives the media.

At operation 603a, a request for sending uplink video datastream sequence message is transmitted from the device 160b, and the UE 150 receives the request for sending uplink video datastream sequence message. At operation 603b, a request for sending uplink audio datastream sequence message is transmitted from the device 160a, and the UE 150 receives the request for sending uplink audio datastream sequence message. The UE 150 replies to the request for sending uplink video datastream sequence message at operation 603c with a send video datastream message that is received by the device 160b. The UE 150 replies to the request for sending uplink audio datastream sequence message at operation 603d with send audio datastream message that is received by the device 160a.

Operations 604a-605b may refer to the synchronous audio and video data transfer using RTP protocols described above and/or UDP for several peers in parallel. In various embodiments, the transmitted video and audio data may be transmitted in accordance with the techniques described above, such as in FIG. 3B.

For example, at operation 604a, the device 160b transmits the first video data packet to the UE 150, and the UE 150 receives the first video data packet. At operation 604b, the device 160a transmits the first audio data packet to the UE 150, and the UE 150 receives the first audio packet. At operation 604c, the UE 150 transmits the first video data packet to the network system 100, and the network system 100 receives the first video data packet. At operation 604d, the UE 150 transmits the first audio data packet to the network system 100, and the network system 100 receives the first audio data packet. Operations 604c and 604d may be transmitted synchronously in time and/or phase, or approximately synchronously in time and/or phase.

Although not shown in FIGS. 6A and 6B, the UE 150 continues to receive subsequent video data packets from the device 160b and subsequent audio data packets from the device 160a, and the UE 150 continues to receive the subsequent video and audio data packets from the respective devices 160b and 160a. The UE 150 then continues to transmit subsequent video data packets and subsequent audio data packets to the network system 100, and the network system continues to receive the subsequent video and audio data packets. The receiving and transmission of subsequent video data packets and audio data packets continues until the UE 150 receives and transmits the last video data packet and last audio data packet as shown in operations 605a-605d.

At operation 605a, the device 160b transmits the last video data packet to the UE 150, and the UE 150 receives the last video data packet. At operation 605b, the device 160a transmits the last audio data packet to the UE 150, and the UE 150 receives the last audio packet. At operation 605c, the UE 150 transmits the last video data packet to the network system 100, and the network system 100 receives the last video data packet. At operation 605d, the UE 150 transmits the last audio data packet to the network system 100, and the network system 100 receives the last audio data packet. Operations 605c and 605d may be transmitted synchronously in time and/or phase, or approximately synchronously in time and/or phase.

Once the last video data packet and the last audio data packet is received by the network system 100, the connection for audio and video data between devices 160 and the UE 150 may be terminated at operations 606a-606d. In various example embodiments, the operations and signals at operations 606a-606d may be non-synchronous.

At operation 606a, the device 160b transmits a “request to end video session” message to the UE 150, and the UE 150 receives the “request to end video session” message. At operation 606b, the device 160a transmits a “request to end audio session” message to the UE 150, and the UE 150 receives the “request to end audio session” message. In response to receiving the “request to end video session” message, at operation 606c, the UE 150 transmits a “confirming to end video session” message to the device 160b, and the device 160b receives the “confirming to end video session” message and the device 160b receives the “confirming to end video session” message. In response to receiving the “request to end audio session” message, at operation 606b, at operation 606d, the UE 150 transmits a “confirming to end audio session” message to the device 160a, and the device 160a receives the “confirming to end audio session” message.

The signals and operations of FIGS. 6A and 6B are merely illustrative, and variations are contemplated to be within the scope of the present disclosure. In embodiments, the signals and operations may include others not illustrated in FIGS. 6A and 6B. In embodiments, the signals and operations may not include every signal and operation illustrated in FIGS. 6A and 6B. In embodiments, the signals and operations may be implemented in a different order than that illustrated in FIGS. 6A and 6B. Such and other embodiments are contemplated to be within the scope of the present disclosure.

Referring now to FIG. 7, there is shown a block diagram of example components of a UE, connected device, or a network apparatus (e.g., of a RAN or a core network). The apparatus includes an electronic storage 710, a processor 720, a network interface 740, and a memory 750. The various components may be communicatively coupled with each other. The processor 720 may be and may include any type of processor, such as a single-core central processing unit (CPU), a multi-core CPU, a microprocessor, a digital signal processor (DSP), a System-on-Chip (SoC), or any other type of processor. The memory 750 may be a volatile type of memory, e.g., RAM, or a non-volatile type of memory, e.g., NAND flash memory. The memory 750 includes processor-readable instructions that are executable by the processor 720 to cause the apparatus to perform various operations, including those mentioned herein, such as the operations shown and described in connection with FIGS. 3A-6B.

The electronic storage 710 may be and include any type of electronic storage used for storing data, such as hard disk drive, solid state drive, and/or optical disc, among other types of electronic storage. The electronic storage 710 stores processor-readable instructions for causing the apparatus to perform its operations and stores data associated with such operations, such as storing data relating to 5G NR standards, among other data. The network interface 740 may implement wireless networking technologies such as 5G NR and/or other wireless networking technologies.

The components shown in FIG. 7 are merely examples, and persons skilled in the art will understand that an apparatus includes other components not illustrated and may include multiples of any of the illustrated components. Such and other embodiments are contemplated to be within the scope of the present disclosure.

Further embodiments of the present disclosure include the following examples.

Example 1.1 A user equipment (UE), comprising:
at least one processor; and
at least one memory storing instructions which, when executed by the at least one processor, cause the user equipment at least to perform:
   receiving a first signal from a first apparatus, the first signal comprising a first data for presentation by a second apparatus in communication with the UE and a second data for presentation by a third apparatus in communication with the UE, the first data and the second data being synchronized with each other in time;
   extracting the first data from the first signal;
   extracting the second data from the first signal;
   determining a timing for transmitting a second signal that comprises the first data to the second apparatus and for transmitting a third signal that comprises the second data to the third apparatus, the timing configured to approximately synchronize in time presentation of the first data by the second apparatus and presentation of the second data by the third apparatus;
   transmitting the second signal to the second apparatus based on the timing; and
   transmitting the third signal to the third apparatus based on the timing.

Example 1.2. The user equipment of Example 1.1, wherein the determining the timing includes determining a processing and transmission delay of the second apparatus.

Example 1.3. The user equipment of Examples 1.1 or 1.2, wherein the determining the timing includes determining a processing and transmission delay of the third apparatus.

Example 1.4. The user equipment of any of Examples 1.1-1.3, wherein the transmitting the second signal to the second apparatus is at a first time and the transmitting the third signal to the third apparatus is at a second time.

Example 1.5. The user equipment of any of Examples 1.1-1.4, wherein the transmitting the second signal to the second apparatus is prior to the transmitting the third signal to the third apparatus.

Example 1.6. The user equipment of any of Examples 1.1-1.3, wherein the instructions, when executed by the at least one processor, further cause the user equipment to perform encoding a first presentation time delay in the second signal, the first presentation time delay configured to approximately synchronize in time the presentation of the first data with the presentation of the second data in the third signal.

Example 1.7. The user equipment of any of Examples 1.1-1.6, wherein the first data includes a first datastream and the second data includes a second datastream.

Example 1.8. The user equipment of Examples 1.1-1.7, wherein the first datastream is an audio datastream and the second data is a video datastream.

Example 1.9. The user equipment of any of Examples 1.1-1.8, wherein the instructions, when executed by the at least one processor, further cause the user equipment to perform decoding and processing the first data.

Example 1.10. The user equipment of any of Examples 1.1-1.9, wherein the instructions, when executed by the at least one processor, further cause the user equipment to perform decoding and processing the second data.

Example 2.1. A user equipment (UE), comprising:
at least one processor; and
at least one memory storing instructions which, when executed by the at least one processor, causes the user equipment at least to perform:
   receiving a first signal comprising first data from a first apparatus in communication with the UE;
   receiving a second signal comprising second data from a second apparatus in communication with the UE;
   determining a timing which synchronizes the first data and the second data in time;
   generating, based on the timing, a third signal comprising the first data and the second data, the first data and the second data being synchronized in time in the third signal; and
   transmitting the third signal to a third apparatus.

Example 2.2. The user equipment of Example 2.1, wherein the determining the timing includes determining a processing and transmission delay of the first apparatus.

Example 2.3. The user equipment of Example 2.1 or 2.2, wherein the determining the timing includes determining a processing and transmission delay of the second apparatus.

Example 2.4. The user equipment of Example 2.3, wherein the generating the third signal includes mixing the first data of the first signal with the second data of the second signal into the third signal.

Example 2.5. The user equipment of any of Examples 2.1-2.4, wherein the generating the third signal includes synchronizing a presentation time of the first data with a presentation time of the second data in the third signal for presentation by the third apparatus.

Example 2.6. The user equipment of Example 2.5, wherein the synchronizing the presentation time of the first data with the presentation time of the second data in the third signal for presentation by the third apparatus includes synchronizing data packets of the first data with data packets of the second data in time.

Example 2.7. The user equipment of any of Examples 2.1-2.6, wherein the first data includes a first datastream and the second data includes a second datastream.

Example 2.8. The user equipment of Example 2.7, wherein the first datastream is an audio datastream and the second data is a video datastream.

Example 2.9. The user equipment of any of Examples 2.1-2.8, wherein the instructions, when executed by the at least one processor, further cause the user equipment to perform encoding and processing the first data.

Example 2.10. The user equipment of any of Examples 2.1-2.9, wherein the instructions, when executed by the at least one processor, further cause the user equipment to perform encoding and processing the second data.

Example 3.1. A method, comprising:
receiving, by a user equipment (UE), a first signal from a first apparatus, the first signal comprising first data for presentation by a second apparatus in communication with the UE and second data for presentation by a third apparatus in communication with the UE, the first data and the second data being synchronized with each other in time;
extracting, by the UE, the first data from the first signal;
extracting, by the UE, the second data from the first signal;
determining, by the UE, a timing for presentation of the first data by the second apparatus and presentation of the second data by the third apparatus, the timing configured to approximately synchronize in time presentation of the first data by the second apparatus and presentation of the second data by the third apparatus;
transmitting, by the UE, a second signal that comprises the first data to the second apparatus; and
transmitting, by the UE, a third signal that comprises the second data to the third apparatus,
wherein at least one of the second signal or the third signal comprises an encoded presentation delay based on the timing.

Example 3.2. The method of Example 3.1, wherein the second signal and the third signal are sequentially transmitted.

Example 3.3. The method of any of Examples 3.1-3.2, further comprising:
determining a first transmission delay from the UE to the second apparatus; and
determining a second transmission delay from the UE to the third apparatus,
wherein the timing is based on the first transmission delay and the second transmission delay.

Example 4.1. A user equipment comprising:
at least one processor; and
at least one memory storing instructions which, when executed by the at least one processor, causes the user equipment at least to perform:
   receiving a first signal from a first apparatus, the first signal comprising first data for presentation by a second apparatus in communication with the UE and second data for presentation by a third apparatus in communication with the UE, the first data and the second data being synchronized with each other in time;
   extracting the first data from the first signal;
   extracting the second data from the first signal;
   determining a timing for presentation of the first data by the second apparatus and for presentation of the second data by the third apparatus, the timing configured to approximately synchronize in time presentation of the first data by the second apparatus and presentation of the second data by the third apparatus;
   transmitting, by the UE, a second signal that comprises the first data to the second apparatus; and
   transmitting, by the UE, a third signal that comprises the second data to the third apparatus,
   wherein at least one of the second signal and the third signal comprises an encoded presentation delay based on the timing.

Example 4.2. The user equipment of Example 4.1, wherein the second signal and the third signal are sequentially transmitted.

Example 4.3. The user equipment of Example 4.1 or 4.2, further comprising:
determining a first transmission delay from the UE to the second apparatus; and
determining a second transmission delay from the UE to the third apparatus,
wherein the timing is based on the first transmission delay and the second transmission delay.

Example 5.1. A processor-readable medium storing instructions which, when executed by at least one process or a use equipment (UE), causes the UE at least to perform:
receiving, by a user equipment (UE), a first signal from a first apparatus, the first signal comprising first data for presentation by a second apparatus in communication with the UE and second data for presentation by a third apparatus in communication with the UE, the first data and the second data being synchronized with each other in time;
extracting, by the UE, the first data from the first signal;
extracting, by the UE, the second data from the first signal;
determining, by the UE, a timing for presentation of the first data by the second apparatus and presentation of the second data by the third apparatus, the timing configured to approximately synchronize in time presentation of the first data by the second apparatus and presentation of the second data by the third apparatus;
transmitting, by the UE, a second signal that comprises the first data to the second apparatus; and
transmitting, by the UE, a third signal that comprises the second data to the third apparatus,
wherein at least one of the second signal or the third signal comprises an encoded presentation delay based on the timing.

Example 5.2. The processor-readable medium of Example 5.1, wherein the second signal and the third signal are sequentially transmitted.

Example 5.3. The processor-readable medium of any of Examples 5.1-5.2, wherein the instructions, when executed by the at least one processor, further cause the UE at least to perform:
determining a first transmission delay from the UE to the second apparatus; and
determining a second transmission delay from the UE to the third apparatus,
wherein the timing is based on the first transmission delay and the second transmission delay.

Example 6.1. A user equipment (UE) comprising:
means for receiving, by a user equipment (UE), a first signal from a first apparatus, the first signal comprising first data for presentation by a second apparatus in communication with the UE and second data for presentation by a third apparatus in communication with the UE, the first data and the second data being synchronized with each other in time;
means for extracting, by the UE, the first data from the first signal;
means for extracting, by the UE, the second data from the first signal;
means for determining, by the UE, a timing for presentation of the first data by the second apparatus and presentation of the second data by the third apparatus, the timing configured to approximately synchronize in time presentation of the first data by the second apparatus and presentation of the second data by the third apparatus;
means for transmitting, by the UE, a second signal that comprises the first data to the second apparatus; and
means for transmitting, by the UE, a third signal that comprises the second data to the third apparatus,
wherein at least one of the second signal or the third signal comprises an encoded presentation delay based on the timing.

Example 6.2. The user equipment of Example 6.1, wherein the second signal and the third signal are sequentially transmitted.

Example 6.3. The use equipment of any of Examples 6.1-6.2, further comprising:
means for determining a first transmission delay from the UE to the second apparatus; and
means for determining a second transmission delay from the UE to the third apparatus,
wherein the timing is based on the first transmission delay and the second transmission delay.

Example 7.1 A user equipment (UE), comprising:
means for receiving a first signal from a first apparatus, the first signal comprising a first data for presentation by a second apparatus in communication with the UE and a second data for presentation by a third apparatus in communication with the UE, the first data and the second data being synchronized with each other in time;
means for extracting the first data from the first signal;
means for extracting the second data from the first signal;
means for determining a timing for transmitting a second signal that comprises the first data to the second apparatus and for transmitting a third signal that comprises the second data to the third apparatus, the timing configured to approximately synchronize in time presentation of the first data by the second apparatus and presentation of the second data by the third apparatus;
means for transmitting the second signal to the second apparatus based on the timing; and
means for transmitting the third signal to the third apparatus based on the timing.

Example 7.2. The user equipment of Example 7.1, wherein the means for determining the timing includes means for determining a processing and transmission delay of the second apparatus.

Example 7.3. The user equipment of Examples 7.1 or 7.2, wherein the means for determining the timing includes means for determining a processing and transmission delay of the third apparatus.

Example 7.4. The user equipment of any of Examples 7.1-7.3, wherein the transmitting the second signal to the second apparatus is at a first time and the transmitting the third signal to the third apparatus is at a second time.

Example 7.5. The user equipment of any of Examples 7.1-7.4, wherein the transmitting the second signal to the second apparatus is prior to the transmitting the third signal to the third apparatus.

Example 7.6. The user equipment of any of Examples 7.1-7.3, further comprising: means for encoding a first presentation time delay in the second signal, the first presentation time delay configured to approximately synchronize in time the presentation of the first data with the presentation of the second data in the third signal.

Example 7.7. The user equipment of any of Examples 7.1-7.6, wherein the first data includes a first datastream and the second data includes a second datastream.

Example 7.8. The user equipment of Examples 7.1-7.7, wherein the first datastream is an audio datastream and the second data is a video datastream.

Example 7.9. The user equipment of any of Examples 7.1-7.8, further comprising: means for decoding and processing the first data.

Example 7.10. The user equipment of any of Examples 7.1-7.9, further comprising: means for decoding and processing the second data.

Example 8.1. A user equipment (UE), comprising:
means for receiving a first signal comprising first data from a first apparatus in communication with the UE;
means for receiving a second signal comprising second data from a second apparatus in communication with the UE;
means for determining a timing which synchronizes the first data and the second data in time;
means for generating, based on the timing, a third signal comprising the first data and the second data, the first data and the second data being synchronized in time in the third signal; and
means for transmitting the third signal to a third apparatus.

Example 8.2. The user equipment of Example 8.1, wherein the means for determining the timing includes means for determining a processing and transmission delay of the first apparatus.

Example 8.3. The user equipment of Example 8.1 or 8.2, wherein the means for determining the timing includes means for determining a processing and transmission delay of the second apparatus.

Example 8.4. The user equipment of Example 8.3, wherein the means for generating the third signal includes means for mixing the first data of the first signal with the second data of the second signal into the third signal.

Example 8.5. The user equipment of any of Examples 8.1-8.4, wherein the means for generating the third signal includes means for synchronizing a presentation time of the first data with a presentation time of the second data in the third signal for presentation by the third apparatus.

Example 8.6. The user equipment of Example 8.5, wherein the means for synchronizing the presentation time of the first data with the presentation time of the second data in the third signal for presentation by the third apparatus includes means for synchronizing data packets of the first data with data packets of the second data in time.

Example 8.7. The user equipment of any of Examples 8.1-8.6, wherein the first data includes a first datastream and the second data includes a second datastream.

Example 8.8. The user equipment of Example 8.7, wherein the first datastream is an audio datastream and the second data is a video datastream.

Example 8.9. The user equipment of any of Examples 8.1-8.8, further comprising means for encoding and processing the first data.

Example 8.10. The user equipment of any of Examples 8.1-8.9, further comprising means for encoding and processing the second data.

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed is:

1. A method of communication, the method comprising:
receiving, by a wireless communication function of a user equipment (UE), a first signal from a network apparatus of a network system, the first signal comprising:
a first data for presentation by a peripheral apparatus associated with the UE and in communication with the UE and
a second data for presentation by another peripheral apparatus associated with of the UE and in communication with the UE, the first data and the second data being synchronized with each other in time;
extracting, by a media access function (MAF) of the UE, the first data from the first signal;
extracting, by the MAF of the UE, the second data from the first signal;
determining, by the MAF of the UE, a timing for transmitting a second signal that comprises the first data to the peripheral apparatus and for transmitting a third signal that comprises the second data to the another peripheral apparatus, the timing configured to approximately synchronize in time presentation of the first data by the peripheral apparatus and presentation of the second data by the another peripheral apparatus;
transmitting, by the wireless communication function of the UE, the second signal to the peripheral apparatus based on the timing; and
transmitting, by the wireless communication function of the UE, the third signal to the another peripheral apparatus based on the timing.

2. The method as claimed in claim 1, further comprising determining at least a processing and transmission delay of the peripheral apparatus,
wherein the determining the timing comprises determining the timing based at least on the processing and transmission delay of the peripheral apparatus.

3. The method as claimed in claim 2, further comprising determining a processing and transmission delay of the another peripheral apparatus,
wherein the determining the timing comprises determining the timing based at least on the processing and transmission delay of the another peripheral apparatus.

4. The method as claimed in claim 1, wherein:
the transmitting the second signal to the peripheral apparatus based on the timing comprises transmitting the second signal to the peripheral apparatus at a first time, and
the transmitting the third signal to the another peripheral apparatus based on the timing comprises transmitting the third signal to the another peripheral apparatus at a second time different from the first time.

5. The method as claimed in claim 4, wherein the first time precedes the second time.

6. The method as claimed in claim 1, further comprising encoding, based on the timing, a first presentation time offset in the second signal.

7. The method as claimed in claim 1, wherein the first data includes a first datastream and the second data includes a second datastream.

8. The method as claimed in claim 7, wherein the first datastream is one of an audio datastream or a video datastream and the second data is the other of the audio datastream and the video datastream.

9. The method as claimed in claim 1, further comprising decoding and processing the first data.

10. The method as claimed in claim 9, further comprising decoding and processing the second data.

11. A user equipment (UE), comprising:
at least one processor; and
at least one memory storing instructions which, when executed by the at least one processor, cause the UE at least to perform operations, the operations comprising:
receiving, by a wireless communication function of the UE, a first signal from a network apparatus of a network system, the first signal comprising:
a first data for presentation by a peripheral apparatus associated with the UE and in communication with the UE and
a second data for presentation by another peripheral apparatus associated with of the UE and in communication with the UE, the first data and the second data being synchronized with each other in time;
extracting, by a media access function (MAF) of the UE, the first data from the first signal;
extracting, by the MAF of the UE, the second data from the first signal;
determining, by the MAF of the UE, a timing for transmitting a second signal that comprises the first data to the peripheral apparatus and for transmitting a third signal that comprises the second data to the another peripheral apparatus, the timing configured to approximately synchronize in time presentation of the first data by the peripheral apparatus and presentation of the second data by the another peripheral apparatus;
transmitting, by the wireless communication function of the UE, the second signal to the peripheral apparatus based on the timing; and
transmitting, by the wireless communication function of the UE, the third signal to the another peripheral apparatus based on the timing.

12. The user equipment as claimed in claim 1,
wherein the operations further comprise determining at least a processing and transmission delay of the peripheral apparatus,
wherein the determining the timing comprises determining the timing based at least on the processing and transmission delay of the peripheral apparatus.

13. The UE as claimed in claim 2,
wherein the operations further comprise determining a processing and transmission delay of the another peripheral apparatus,
wherein the determining the timing comprises determining the timing based at least on the processing and transmission delay of the another peripheral apparatus.

14. The UE as claimed in claim 1,
wherein the transmitting the second signal to the peripheral apparatus based on the timing comprises transmitting the second signal to the peripheral apparatus at a first time, and
wherein the transmitting the third signal to the another peripheral apparatus based on the timing comprises transmitting the third signal to the another peripheral apparatus at a second time different from the first time.

15. The UE as claimed in claim 4, wherein the first time precedes the second time.

16. The UE as claimed in claim 1, wherein the operations further comprise encoding, based on the timing, a first presentation time offset in the second signal.

17. The UE as claimed in claim 1, wherein the first data includes a first datastream and the second data includes a second datastream.

18. The UE as claimed in claim 7, wherein the first datastream is one of an audio datastream or a video datastream and the second data is the other of the audio datastream and the video datastream.

19. The UE as claimed in claim 1, wherein the operations further comprise decoding and processing the first data.

20. A processor-readable medium storing instructions which, when executed by at least one processor of a user equipment (UE), cause the UE at least to perform operations, the operations comprising:
receiving, by a wireless communication function of the UE, a first signal from a network apparatus of a network system, the first signal comprising:
a first data for presentation by a peripheral apparatus associated with the UE and in communication with the UE and
a second data for presentation by another peripheral apparatus associated with of the UE and in communication with the UE, the first data and the second data being synchronized with each other in time;
extracting, by a media access function (MAF) of the UE, the first data from the first signal;
extracting, by the MAF of the UE, the second data from the first signal;
determining, by the MAF of the UE, a timing for transmitting a second signal that comprises the first data to the peripheral apparatus and for transmitting a third signal that comprises the second data to the another peripheral apparatus, the timing configured to approximately synchronize in time presentation of the first data by the peripheral apparatus and presentation of the second data by the another peripheral apparatus;
transmitting, by the wireless communication function of the UE, the second signal to the peripheral apparatus based on the timing; and
transmitting, by the wireless communication function of the UE, the third signal to the another peripheral apparatus based on the timing.
